(19) United States
(12) Patent Application Publication
(10) Pub. No.: US 2025/0141729 A1
(43) Pub. Date: May 1, 2025

(54) Scale Out Compatibility Chiplets for Automotive Computing Architecture

(71) Applicant: Tenstorrent Al ULC, Toronto (CA)

(72) Inventors: Yongbum Kim, Los Altos Hills, CA (US); Wei-han Lien, Saratoga, CA (US); Luke Yen, Woodinville, WA (US); Thaddeus Fortenberry, Dripping Springs, TX (US)

(21) Appl. No.: 18/931,777

(22) Filed: Oct. 30, 2024

Related U.S. Application Data
(60) Provisional application No. 63/546,520, filed on Oct. 30, 2023.

(51) Int. Cl. H04L 41/04; B60R 16/023; H04L 67/125

(52) U.S. Cl. CPC H04L 41/04; B60R 16/023; H04L 67/125

(57) ABSTRACT

This disclosure relates to automotive computing architectures and more specifically to specialized discrete scale out computational elements that enhance the performance of an automotive computing architecture in terms of efficient networking and sensor data processing. A disclosed automotive computing architecture includes a set of zones, a zonal network, a sensor in a first zone, and an actuator in a second zone. A discrete computational element, in the first zone, receives sensor data from the sensor according to a legacy protocol, and is programmed to process the sensor data to produce a command therefrom and packages the command in the legacy protocol with an Ethernet packet. A second discrete computational element, in a second zone, is coupled to the actuator and is programmed to receive the Ethernet packet with the command, unpack the command into the legacy protocol, and provide the command in the legacy protocol to the actuator.

### CROSS REFERENCE TO RELATED APPLICATIONS

This application claims the benefit of U.S. Provisional Patent Application No. 63/546,520, filed Oct. 30, 2023, which is incorporated by reference herein in its entirety for all purposes.

### BACKGROUND

Automotive computing architectures are evolving rapidly as vehicles become more dependent on electronics, software, and connectivity. Traditionally, vehicles employed distributed systems with numerous Electronic Control Units (ECUs), each responsible for specific functions such as engine control, braking, and infotainment. These ECUs were powered by Microcontroller Units (MCUs), which provided the necessary computational power for real-time control and processing of various vehicle systems. However, with the increasing complexity of modern vehicles—especially electric and autonomous models—there is a shift towards centralized computational architectures with zonal networks. In this setup, fewer but more powerful computing units, often combining multiple MCUs or using high-performance processors, manage broader functions and handle larger data loads from sensors, cameras, and radar. MCUs continue to play a crucial role in these architectures by managing critical tasks such as real-time sensor data processing, powertrain control, and advanced driver-assistance systems (ADAS).

As automotive computing architectures shift towards centralized and zonal designs, the role of MCUs becomes even more critical in managing communication across the vehicle's vast network of sensors and actuators. MCUs must be able to interface with various communication protocols such as Controller Area Network (CAN), Local Interconnect Network (LIN), Autonomous Vehicle Technology Platform (ATVP), and Automotive Ethernet to ensure smooth data flow between different vehicle systems. These protocols are essential for transmitting real-time data between sensors—such as those monitoring speed, temperature, and proximity—and actuators that control mechanical functions like braking, steering, and engine response. CAN, for instance, is widely used for communication in engine and powertrain control, while LIN is commonly deployed for simpler subsystems like window regulators and climate control. ATVP, with its higher bandwidth capabilities, supports advanced systems like infotainment and autonomous driving technologies. MCUs must not only handle the specific protocols of these networks but also ensure they can operate reliably under stringent automotive conditions, such as extreme temperatures and electromagnetic interference. As vehicles become more complex and interconnected, MCUs need to maintain seamless communication across these protocols to ensure the vehicle's safety, performance, and user experience.

### SUMMARY

This disclosure relates to automotive computing architectures and more specifically to automotive computing architectures with specialized discrete scale out computational elements that enhance the performance of a computing architecture in terms of efficient networking and sensor data processing. The discrete computational elements can be individual chips, individual chiplets, sets of integrated chiplets, individually packaged systems-on-chip, individually packaged MCUs, or various other discrete components that can be purchased from a semiconductor company and integrated into the design of an automotive computing architecture.

In specific embodiments, the discrete computational elements can assist in the scale out of an automotive computational architecture. The discrete computational elements can communicate with a set of one or more sensors using various legacy protocols and package all communications within the Ethernet protocol. In specific embodiments, a message originally in a legacy protocol may fit in a single Ethernet packet. In specific embodiments, a message originally in a legacy protocol may fit in multiple Ethernet packets. The discrete computational elements can communicate with other computational elements or higher-level controllers using Ethernet by transmitting such packets through a network. The discrete computational elements can also send commands downstream to actuators using various legacy protocols. The discrete computational elements can receive commands for the actuators through the network using Ethernet and then unpack those commands into the legacy protocols used by the actuators. This approach is beneficial as the efficiency of Ethernet may be used when communicating between zones while refraining from performing additional translations or similar steps.

In specific embodiments, the sensors and actuators in an automotive computing system are designed to communicate via Ethernet (e.g., as a native language). In specific embodiments, discrete computational elements can process sensor data for a specific zone in an automotive zonal network. The discrete computational elements can communicate with other computational elements or higher-level controllers using Ethernet. Commands can be sent downstream to actuators using Ethernet and commands for the actuators can be received using Ethernet. The control information and sensor data may be used and produced by the sensors and actuators as part of Ethernet protocol and may be transported in Ethernet without additional packaging or converting steps. This approach is beneficial as processing messages between components of the system is minimized, as many or all components are able to operate using Ethernet.

In specific embodiments, the discrete computational elements can assist in the scale out of an automotive computational architecture. The discrete computational elements can process sensor data for a specific zone in an automotive zonal network. The discrete computational elements can communicate with a set of one or more sensors using various legacy protocols and convert all communication to Ethernet. The discrete computational elements can then communicate with other computational elements or higher-level controllers using Ethernet. The discrete computational elements can also send commands downstream to actuators using various legacy protocols. The discrete computational elements can receive commands for the actuators using Ethernet and then translate those commands into the legacy protocols used by the actuators.

In specific embodiments, the discrete computational elements can assist in scaling out automotive computing architectures with legacy sensors and actuators by processing the sensor data and generating commands for the legacy sensors locally, packaging the commands into Ethernet packets, and sending the commands to different zones where they can be unpacked back into commands in a legacy protocol of the actuators. This approach leads to beneficial results in that it reduces congestion on the network of the automotive computing architecture by processing sensor data locally within zones and only transmitting summaries of that data or commands generated in response to the data through the network. In this approach, zone controllers of the network package legacy commands into Ethernet packets to tunnel them through the network.

In specific embodiments, the discrete computational elements can include operating systems for running software stacks and can be loaded with open-source software stacks to process the sensor data from various legacy protocols. In specific embodiments, the software stacks can be modified by the manufacturer of the computational elements to operate with a proprietary protocol in which the commands are issued as set by the developer of the automotive computing architecture.

In specific embodiments of the invention, an automotive computing architecture is provided. The automotive computing architecture comprises: a set of zones, a zonal network providing communicative coupling between the zones in the set of zones, a sensor in a first zone of the set of zones, an actuator in a second zone of the set of zones, and a discrete computational element in the first zone of the set of zones. The discrete computational element is coupled to the sensor to receive sensor data according to a legacy protocol and is programmed to process the sensor data to produce a command therefrom (the command being in the legacy protocol) and package the command for the zonal network, where the command is packaged as an Ethernet packet. The automotive computing architecture further comprises a second discrete computational element in the second zone of the set of zones. The second discrete computational element is coupled to the actuator and is programmed to: receive the Ethernet packet with the command, unpack the command into the legacy protocol, and provide the command (unpacked into the legacy protocol) to the actuator.

In specific embodiments of the invention, a method of operating an automotive computing architecture is provided. The method comprises: collecting sensor data using a sensor in a first zone of a set of zones of a zonal network (the zonal network providing communicative coupling between the zones in the set of zones), receiving the sensor data from the sensor at a discrete computational element in the first zone of the set of zones (the discrete computational element being coupled to the sensor to receive the sensor data according to a legacy protocol), and processing (using the discrete computational element) the sensor data to produce a command therefrom, where the command is in the legacy protocol. The method further comprises packaging (using the discrete computational element) the command in the legacy protocol with an Ethernet packet, where the command is for the zonal network. The method further comprises: transmitting (using the zonal network) the Ethernet packet from the first zone to a second zone in the set of zones, receiving the Ethernet packet at a second discrete computational element in the second zone, unpacking (using the second discrete computational element) the Ethernet packet into the command in the legacy protocol, and providing the command in the legacy protocol to an actuator in the second zone.

In specific embodiments of the invention, a discrete computational element for an automotive computing architecture is provided. The discrete computational element comprises: a sensor coupling to receive sensor data according to a legacy protocol from a sensor in a first zone of a set of zones in a zonal network and an actuator coupling to send a command in the legacy protocol to an actuator in the first zone, wherein the discrete computational element is programmed to process the sensor data to produce a command therefrom, generate an Ethernet packet that packages the command (where the command is in the legacy protocol and the Ethernet packet is for the zonal network), receive a second Ethernet packet with a second command, unpack the command into the legacy protocol, and provide the second command (as unpacked into the legacy protocol) to the actuator.

In specific embodiments of the invention, an automotive computing architecture is provided. The automotive computing architecture comprises: a set of zones, a zonal network providing communicative coupling between the zones in the set of zones, a sensor (in a first zone of the set of zones) that produces sensor data according to an Ethernet protocol, an actuator (in a second zone of the set of zones) that understands commands according to the Ethernet protocol, and a discrete computational element in the first zone of the set of zones that is coupled to the sensor to receive sensor data according to the Ethernet protocol and that is programmed to process the sensor data to produce a command therefrom, where the command is in the Ethernet protocol. The automotive computing architecture further comprises a second discrete computational element (in the second zone of the set of zones) that is coupled to the actuator and that is programmed to receive the command in the Ethernet protocol and provide the command to the actuator.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides a top-down diagram of various subsystems in an automotive computing architecture in accordance with the related art.

FIG. 2 provides an example of a system and method for packaging commands in accordance with specific embodiments of the inventions disclosed herein.

FIG. 3 provides an example of a method for using Ethernet protocol for sensor data and commands in accordance with specific embodiments of the inventions disclosed herein.

FIG. 4 provides an example of a custom chip base in accordance with specific embodiments of the inventions disclosed herein.

FIG. 5 provides an example of a system that makes up a portion of the custom chip base in accordance with specific embodiments of the inventions disclosed herein.

FIG. 6 provides an example of a system packaging a legacy protocol command with Ethernet protocol in accordance with specific embodiments of the inventions disclosed herein.

FIG. 7 provides an example of a system packaging a legacy protocol command with Ethernet protocol where the system includes multiple sensors in accordance with specific embodiments of the inventions disclosed herein.

FIG. 8 provides an example of a system with a discrete computational element in accordance with specific embodiments of the inventions disclosed herein.

FIG. 9 provides an example of a system using Ethernet protocol for sensor data and commands in accordance with specific embodiments of the inventions disclosed herein.

FIG. 10 provides an example of a system that translates legacy protocols to Ethernet protocol in accordance with specific embodiments of the inventions disclosed herein.

FIG. 11 provides an example of a method of operating an automotive computing architecture in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for scale out compatibility chiplets for automotive computing architecture will be described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Sensor data may be converted to a command that is sent through a zonal network to an actuator. This may occur using various protocols, packaging, and translating processes. For example, a legacy protocol command may be produced from legacy protocol sensor data, the legacy protocol command may be packaged using Ethernet protocol in a first zone, the Ethernet package may be sent through the zonal network to a second zone, the Ethernet package may be unpacked to access the legacy protocol command in the second zone, and the legacy protocol command may be sent to an actuator to complete the command. As another example, sensors, actuators, and the zonal network may all operate using Ethernet protocol. As another example, a legacy protocol command may be produced from legacy protocol sensor data, the legacy protocol command may be translated to Ethernet protocol in a first zone, the Ethernet command may be sent through the zonal network to a second zone, the Ethernet command may be translated to a legacy protocol (the same or different than the legacy protocol of the sensor data) in the second zone, and the legacy protocol command may be sent to an actuator to complete the command. These native Ethernet, packaging, and translating processes may use discrete computational elements for packaging, translating, producing commands, and otherwise assisting in scaling out an automotive computational architecture.

In specific embodiments, the discrete computational elements can assist in the scale out of an automotive computational architecture by communicating with a set of one or more sensors using various legacy protocols and package all communication within Ethernet protocol. In specific embodiments, a command originally in a legacy protocol may fit in a single Ethernet packet. In specific embodiments, the command originally in a legacy protocol may fit in multiple Ethernet packets. The discrete computational elements can communicate with other computational elements or higher-level controllers using Ethernet. The discrete computational elements can receive commands for the actuators using Ethernet and then unpack those commands into the legacy protocols used by the actuators. This approach is beneficial as the efficiency of Ethernet may be used when communicating between zones while refraining from performing translations or similar steps.

In specific embodiments, sensors and actuators are designed to communicate via Ethernet (e.g., as a native language). In specific embodiments, discrete computational elements can process sensor data for a specific zone in an automotive zonal network to produce a command for another zone. The discrete computational elements processes Ethernet sensor data to produce an Ethernet command, which is communicated with other computational elements or higher-level controllers using Ethernet. Commands can be sent downstream to actuators using Ethernet. Control information and sensor data may be used and produced by the sensors and actuators as part of Ethernet protocol and may be transported in Ethernet without additional packaging or converting steps. This approach is beneficial as processing messages between components of the system is minimized, as many or all components are able to operate using Ethernet.

In specific embodiments, the discrete computational elements can assist in the scale out of an automotive computational architecture by processing legacy protocol sensor data to produce Ethernet commands. The discrete computational elements can communicate with a set of one or more sensors using various legacy protocols, produce a command in Ethernet protocol based on data from the set of one or more sensors, and communicate through the zonal network using Ethernet (e.g., communicate with other computational elements or higher-level controllers using Ethernet). The discrete computational elements can receive commands for the actuators using Ethernet and then translate those commands into the legacy protocols used by the actuators.

In specific embodiments, the discrete computational elements can assist in scaling out automotive computing architectures with legacy sensors and actuators by processing the sensor data and generating commands for the legacy sensors locally, translating the commands into Ethernet, and sending the commands to different zones where they can be translated back into commands in a legacy protocol of the actuators. This approach leads to beneficial results in that it reduces congestion on the network of the automotive computing architecture by processing sensor data locally within zones and only transmitting summaries of that data or command generated in response to the data through the network. In this approach, zone controllers of the network do not package legacy commands into Ethernet packets to tunnel them through the network, but rather translate the commands into Ethernet.

In specific embodiments, the discrete computational elements can include operating systems for running software stacks and can be loaded with open-source software stacks to process the sensor data from various legacy protocols, to translate the sensor data from various legacy protocols into Ethernet, or to translate commands received via Ethernet packets into commands for various legacy protocols. In specific embodiments, the software stacks used to translate commands received via Ethernet packets can be modified by the manufacturer of the computational elements to operate with a proprietary protocol in which the commands are issued as set by the developer of the automotive computing architecture. In specific embodiments, the discrete computational elements may also include microcontrollers and may use roots of trust to encrypt and decrypt message. A system with discrete computational elements may include any number of zones, sensors, and actuators.

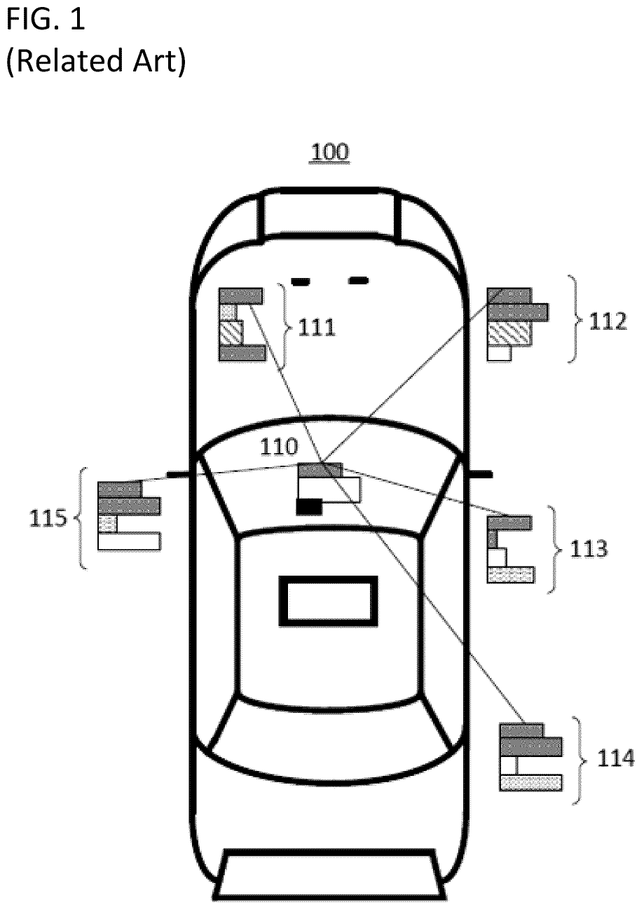

FIG. 1 provides a top-down diagram of various subsystems in automotive computing architecture 100 in accordance with the related art. The automotive computing architecture 100 can include a central controller such as Body Control Module (BCM) 110. The central controller can include a network connection to various groups of subsystems 111, 112, 113, 114, and 115. The various subsystems can control various aspects of the automobile or obtain data from various sensors on the automobile. The subsystems can be organized into groups based on their location in the car as opposed to being grouped based on their function. The network that connects the groups of subsystems can be a zonal network. The BCM 110 can include a power control module (PCM) for the automotive computing architecture, or a separate centralized PCM can control power distribution to the various groups of subsystems. Subsystems 111, 112, 113, 114, and 115 may communicate with BCM 110 using a variety of protocols such as Controller Area Network (CAN), Local Interconnect Network (LIN), advanced technology vehicle programs (ATVP), and Automotive Ethernet.

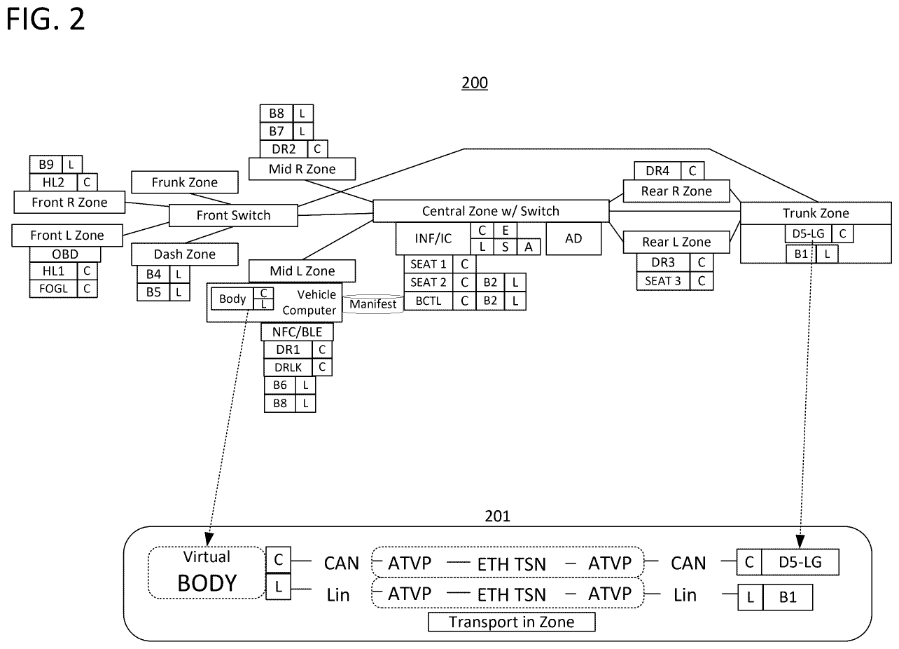

FIG. 2 is directed to a zone diagram of system 200 implementing method 201 for packaging commands in accordance with specific embodiments of the inventions disclosed herein. System 200 is a centralized computational architecture or automotive computing architecture and may include a set of zones (including a first zone and a second zone), a zonal network, a sensor in the first zone (e.g., Mid L Zone), an actuator in the second zone (e.g., Trunk Zone), a first discrete computational element in the first zone, and a second discrete computational element in the second zone. The discrete computational elements may include MCUs and may use root of trust modules to encrypt and decrypt messages. The zonal network may provide communicative coupling between the zones in the set of zones. Multiple MCUs (or high-performance processors) may manage broad functions and handle large data loads from sensors, cameras, and radar. The zone diagram includes modules for near field communication (NFC), Bluetooth low energy (BLE), doors (DR), door locks (DRLK), onboard diagnostics (OBD), headlamp (HL), infotainment (INF), instrument cluster (IC), automated driving (AD), body control module (BCTL), sensors, and at least one actuator. In specific embodiments, hardware sensors that were previously part of a vehicle body may be virtualized in software. In specific embodiments, aspects of system 200 may be rearranged, omitted, or duplicated without deviating from inventive concepts disclosed herein. That is, system 200 as shown is exemplary only.

Discrete computational elements may manage communication across system 200. The discrete computational elements may include MCUs. The discrete computational elements may manage critical tasks such as real-time sensor data processing, powertrain control, and advanced driver-assistance systems (ADAS). The discrete computational elements may interface with various communication protocols of system 200 such as CAN, LIN, ATVP, and Ethernet to ensure smooth data flow between different vehicle systems. These protocols may transmit real-time data between sensors (e.g., monitoring speed, temperature, and proximity) and actuators that control mechanical functions like braking, steering, and engine response. CAN, for instance, may be used for communication in engine and powertrain control in system 200, while LIN may be deployed for simpler subsystems like window regulators and climate control in system 200. ATVP, with its higher bandwidth capabilities, may support advanced systems like the infotainment and autonomous driving technologies of system 200.

System 200 may implement method 201 for transporting messages. Method 201 may preserve the legacy protocol of the message (e.g., data or command) via tunneling. The message may be transported within a zone, from a zone to a central zone, from a zone to another outlying zone, or through one or more intermediate zones to reach a destination zone. Method 201 may include packaging and transporting the message from the body of system 200 to the trunk zone. The message (e.g., legacy protocol message) may be packaged with ATVP protocol and ethernet (ETH) time-sensitive networking (TSN) protocol. For example, the message may be CAN protocol and may be packaged with ATVP protocol then with ETH TSN protocol. As another example, the message may be LIN protocol and may be packaged with ATVP protocol then with ETH TSN protocol. As part of transportation or reception, the message may be unpacked to access the legacy protocol command.

As another example, the first discrete computational element (e.g., in Mid L Zone) may be coupled with the sensor to receive sensor data according to a legacy protocol (e.g., CAN, LIN). The first discrete computational element may be programmed to process the sensor data to produce a command therefrom and package the command for the zonal network. The command may be in the legacy protocol and may be packaged with ATVP and ETH TSN protocol as an Ethernet packet. The second discrete computational element (e.g., in Trunk Zone) may be coupled to the actuator. The second discrete computational element may be programmed to receive the Ethernet packet with the command, unpack the command into the legacy protocol, and provide the command (unpacked into the legacy protocol) to the actuator.

Method 201 may include, for example, a user in a vehicle pressing an “open trunk” button in Mid L Zone. The electric signal from this button press may be converted (e.g., by a discrete computational element) to a command in a legacy protocol at the Mid L Zone. The command may be packaged by one or more protocols including Ethernet protocol and sent through a zonal network to the Trunk Zone. At the trunk zone, the packaged command may be unpacked (e.g., by a second discrete computational element) such that the command is in the original legacy protocol without the additional protocol layers. An actuator in the Trunk Zone may receive the “open trunk” command and open the trunk.

In specific embodiments, an X byte, analog signal, or other message might be too big for a single Ethernet packet. The X byte or analog signal may be sensor data in a legacy protocol that needs to be transported through the automotive computing environment. In this case, the X byte or analog signal may be packaged into multiple Ethernet packets. These multiple packets may be sent through the zonal network and unpacked at the receiving zone.

Packaging legacy protocol commands in Ethernet protocol allows the efficiency and reliability of Ethernet protocol through the zonal network while avoiding translating commands or other messages. This may improve efficiency and reduce latency for communicating commands and other messages.

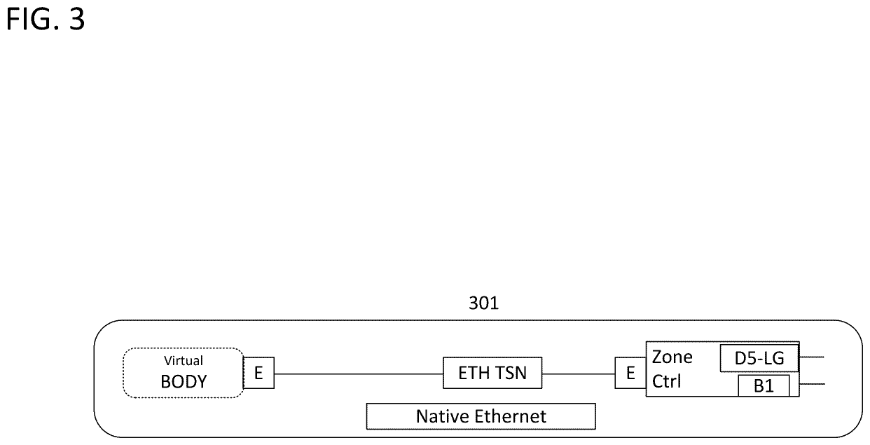

FIG. 3 is directed to method 301 for using Ethernet protocol for sensor data and commands in accordance with specific embodiments of the inventions disclosed herein. Method 301 may be implemented by a system with some components similar to those of system 200. For example, Method 301 may be implemented by an automotive computational architecture divided into zones with zonal networks for communication between zones. The automotive computational architecture may include MCUs (or high-performance processors) and modules for NFC, BLE, doors, door locks, OBD, headlamps, INF, IC, automated driving, BCTL, sensors, and at least one actuator. A zone controller may be integrated with several nearby ECUs, or a local zone controller may eliminate (or reduce the number of) ECUs. The zone controllers may be part of or may include a discrete computational element. The zone controller may connect to actuators (e.g., a DRLK relay actuator). In specific embodiments, the zone controller may only need to take in Ethernet. In specific embodiments, hardware sensors that were previously part of a vehicle body may be virtualized in software. Ethernet protocol (e.g., ETH TSN) may be the native protocol for the automotive computational architecture. In specific embodiment, Industrial Protocol (IP) may be native to the automotive computational architecture. Ethernet and IP protocols may improve efficiency and decrease latency for communication.

In method 301, a message (e.g., sensor data or a command) may be processed and transported using Ethernet protocol. The message may be transported within a zone, from a zone to a central zone, from a zone to another outlying zone, or through one or more intermediate zones to reach a destination zone. Method 301 may include transporting the Ethernet protocol message from the body of a vehicle to the trunk zone of the vehicle. The message may be in ethernet (ETH) time-sensitive networking (TSN) protocol.

As another example, a sensor, in a first zone of the set of zones (e.g., Mid L Zone), may produce sensor data according to an Ethernet protocol. An actuator, in a second zone (e.g., Trunk Zone) of the set of zones, may understand commands according to the Ethernet protocol. A discrete computational element, in the first zone of the set of zones, may be coupled to the sensor to receive sensor data according to the Ethernet protocol and may be programmed to process the sensor data to produce a command therefrom, where the command is in the Ethernet protocol. A second discrete computational element, in the second zone of the set of zones, may be coupled to the actuator and may be programmed to receive the command in the Ethernet protocol and provide the command to the actuator.

Method 301 may include, for example, a user in a vehicle pressing an “open trunk” button in the Mid L Zone of the automotive computational architecture. The sensor data from this button press may use Ethernet protocol. The sensor data may be converted into a command, still in Ethernet protocol, and sent through a zonal network to the Trunk Zone. An actuator in the Trunk Zone may receive the “open trunk” command in Ethernet protocol and open the trunk. The actuator may understand Ethernet protocol and may respond to the command without converting the command to a different protocol.

In specific embodiments, body domain controllers may be integrated into an existing vehicle computer. Method 301 may use native messaging with bypass of CAN/LIN. That is, the system may refrain from using CAN and LIN protocols. With native Ethernet, messages (e.g., sensor data, commands) are low latency and have assured delivery.

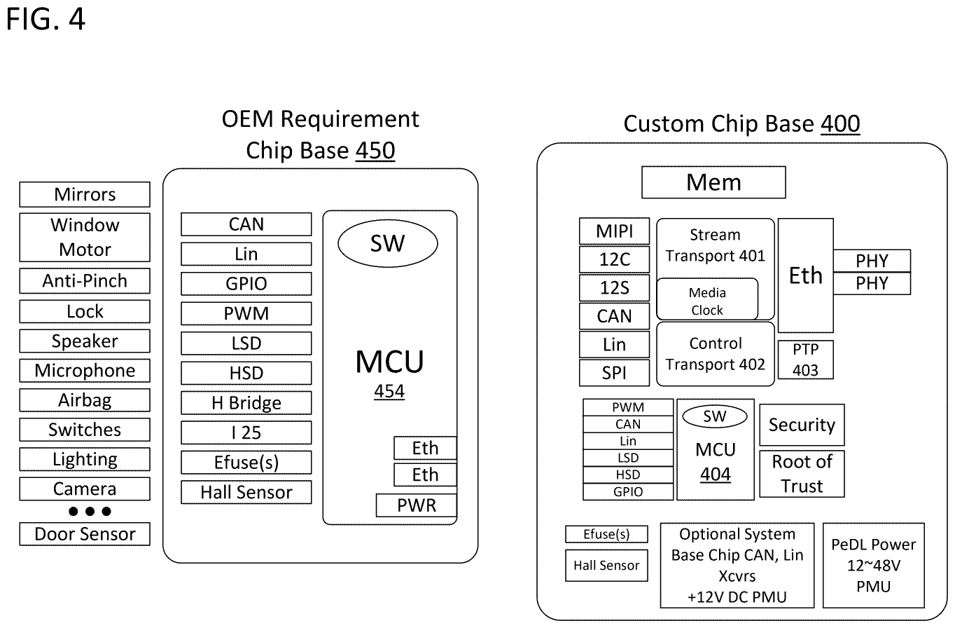

FIG. 4 depicts an example of custom chip base 400 in accordance with specific embodiments of the inventions disclosed herein. FIG. 4 also includes, for comparison, chip base 450 based on Original Equipment Manufacturer (OEM) requirements. In specific embodiments, custom chip base 400 may be part of a door zone. In other embodiments, custom chip base 400 may be part of a zone that is not a door zone. Custom chip base may be able to understand and work in a variety of languages or protocols (e.g., CAN, LIN) and translate information into Ethernet. In specific embodiments, aspects of chip base 400 may be rearranged, omitted, or duplicated without deviating from inventive concepts disclosed herein. That is, chip base 400 is exemplary only.

In chip base 450, the Ethernet stack is completely handled in software while chip base 400 includes dedicated Ethernet stack hardware accelerators (e.g., similar to a data processing unit (DPU) in a data center). Stream transport 401 of chip base 400 may include physical transport links to send/receive Ethernet packets. Control transport 402 may include hardware logic that deals with sending/receiving the Ethernet packets (e.g., routing table lookup, etc.). Precision time protocol (PTP) 403 refers to an IEEE standard for multiple nodes to synchronize on global timestamps. For example, PTP 403 may allow nodes to understand which sensor information is received at what time (e.g., for autonomous driving algorithms).

Chip base 400 may accelerate Ethernet using dedicated hardware blocks to make using Ethernet protocol more time efficient and more energy efficient. Ethernet packet processing in chip base 450 may be done purely in software by MCU 454. By using dedicated hardware blocks for Ethernet, chip base 400 may free space in MCU 404 to be used for other tasks such as handling the autonomous driving algorithm processing. MCU 404 may have an operating system that supports open software stacks.

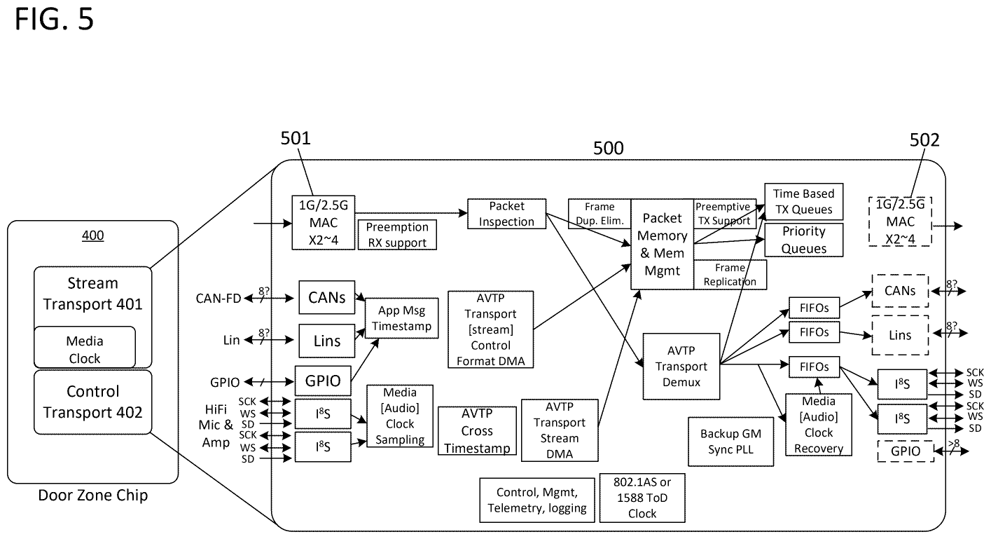

FIG. 5 depicts an example of system 500 that makes up a portion of custom chip base 400 in accordance with specific embodiments of the inventions disclosed herein. For example, system 500 may show a detailed look at stream transport 401 and control transport 402 of chip base 400 (e.g., a streaming and control transport example IP). System 500 includes Ethernet modules 501 and 502. System 500 may be configurable and controllable by software. In specific embodiments, aspects of system 500 may be rearranged, omitted, or duplicated without deviating from inventive concepts disclosed herein. That is, system 500 is exemplary only.

System 500 may process signals. For example, various components of system 500 may convert sensor data into a command for an actuator, may pack or unpack signals, may translate messages (e.g., signals, commands, data) to different protocols, and may relay information. Modules of system 500 may operate using different protocols such as Ethernet, ETH TSN, AVTP, and legacy protocols (e.g., CAN, LIN). In specific embodiments, messages may not need to pack, unpack, or translate signals as sensors and actuators may operate using Ethernet.

Ethernet module 501 may accept Ethernet protocol signals and may process these signals as needed. For example, Ethernet module 501 may unpack a signal containing a command in a legacy protocol. Ethernet module 501 may interpret an Ethernet frame on a message to extract a legacy protocol message. In specific embodiments, Ethernet module 501 may translate an Ethernet protocol signal to legacy protocol or may translate a legacy protocol signal to Ethernet protocol. Ethernet module 501 may send the received message, after appropriate processing, to one or more other portions of system 500.

Ethernet module 502 may accept an internal signal. The internal signal may be an Ethernet protocol signal or a legacy signal. Ethernet module 502 may convert a legacy signal to an Ethernet signal. Ethernet module 502 may send the signal to one or more higher-level controllers or a module in another zone (a zone that is different than the zone containing system 500). In specific embodiments, system 500 may use Ethernet module 501 and Ethernet module 502 to translate messages to and from Ethernet protocol in both directions.

In specific embodiments, embedded processors (e.g., up to 16) may control various aspects of protocol terminations. In specific embodiments, a DPU or DPU-like architecture (e.g., a wire service) may control various aspects of protocol terminations. In specific embodiments, there may be many dedicated hardware accelerators to post-process incoming data packets in each of the legacy protocols (e.g., CAN, LIN) protocols. In specific embodiments, general purpose MCUs (e.g., of an OEM) may perform the same task, but the general purpose MCUs may be less efficient and may take away precious MCU resources that could otherwise be used for other tasks such as ADAS.

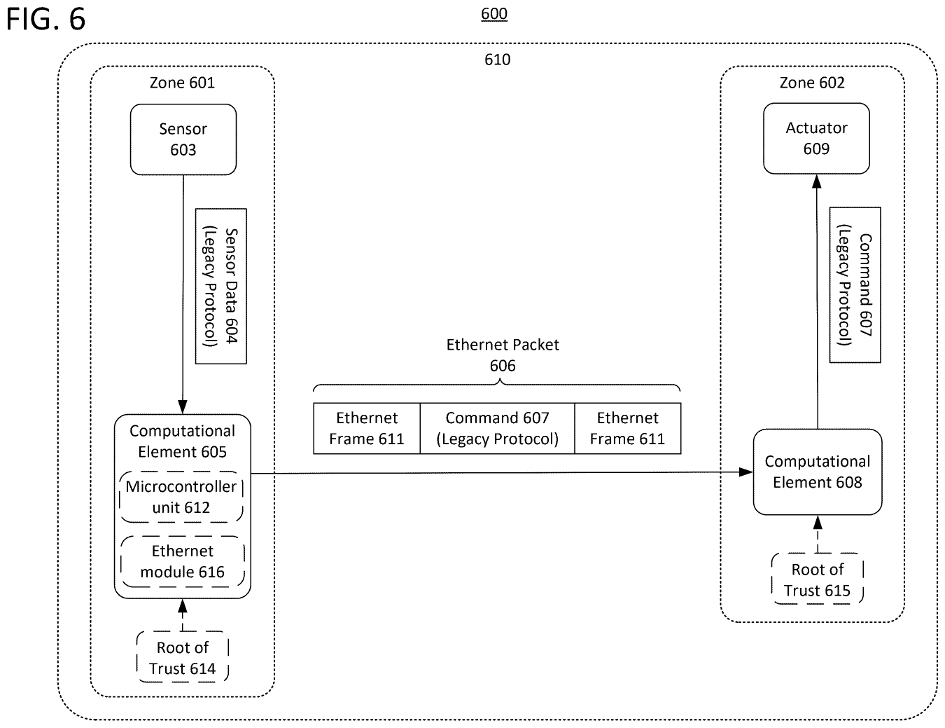

FIG. 6 depicts an example of system 600 packaging legacy protocol command 607 with Ethernet protocol in accordance with specific embodiments of the inventions disclosed herein. System 600 may be an automotive computing architecture and may include a set of zones (including zone 601 and zone 602), zonal network 610, sensor 603 in zone 601, actuator 609 in zone 602, computational element 605 in zone 601, and computational element 608 in zone 602. Computational element 605 and computational element 608 may be discrete computational elements, may be endpoint hardware, and may include or be part of a zone controller. Messaging such as sending sensor data 604, sending Ethernet packet 606, and sending command 607 may be performed using wires, buses, cables, Bluetooth, antenna, or other hardware. Although only two zones are shown, zonal network 610 may include any number of zones.

Zonal network 610 may provide communicative coupling between zones 601 and 602 (as well as additional zones not shown). Computational element 605 may be coupled to sensor 603 to receive (e.g., collect) sensor data 604 according to a legacy protocol. Computational element 605 may be programmed to process sensor data 604 to produce command 607 based on sensor data 604 and may package command 607 to send in zonal network 610. Command 607 may be in the legacy protocol and may be packaged as Ethernet packet 606. In specific embodiments, computational element 605 and computational element 608 may be packaged computational elements. Computational element 605 may include microcontroller unit 612 (e.g., chiplet) for processing sensor data 604 to produce command 607 therefrom. In specific embodiments, microcontroller unit 612 may include an operating system and an open source software stack that is compatible with the operating system and the legacy protocol.

Ethernet packet 606 may be formatted according to Ethernet protocol. To package command 607 as Ethernet packet 606, computational element 605 may place command 607 inside Ethernet frame 611, with a portion of Ethernet frame 611 on either side (or on one side) of command 607. In specific embodiments, system 600 may include Ethernet module 616 for packaging command 607 as Ethernet packet 606. In specific embodiments, “packaging” may also be referred to as “tunneling” using encapsulated packets. For example, a CAN message containing header and data packets may be encapsulated entirely as the “data payload” portion of an Ethernet packet (e.g., Ethernet packet 606). In specific embodiments, computational element 605 may use root of trust module 614 to encrypt packets (e.g., Ethernet packet 606) sent on zonal network 610. Although shown in zone 601, root of trust module 614 may be located outside of zone 601 or may be part of computational element 605. In specific embodiments, computational element 605 may send command 607 from zone 601 to zone 602 without additional processing, such as by an engine control unit.

Computational element 608 may be coupled to actuator 609. Computational element 608 may be programmed to receive Ethernet packet 606 containing command 607 and unpack command 607 such that it is in legacy protocol. In specific embodiments, “unpacking” may be referred to as “decoding” Ethernet packet 606. The receiver may decode the Ethernet packet header (e.g., part of Ethernet frame 611), find out that this encapsulation has occurred, and decode the data payload as a CAN message with its original CAN header and data packet (e.g., command 607). In specific embodiments, computational element 608 may use root of trust module 615 to decrypt the packets (e.g., Ethernet packet 606) sent on zonal network 610. Although shown in zone 602, root of trust module 615 may be located outside of zone 602 or may be part of computational element 605. Computational element 608 may provide command 607 (unpacked into the legacy protocol) to actuator 609.

Packaging legacy protocol commands in Ethernet protocol allows the efficiency and reliability of Ethernet protocol through the zonal network while avoiding translating commands or other messages. This may improve efficiency and reduce latency for communicating commands and other messages.

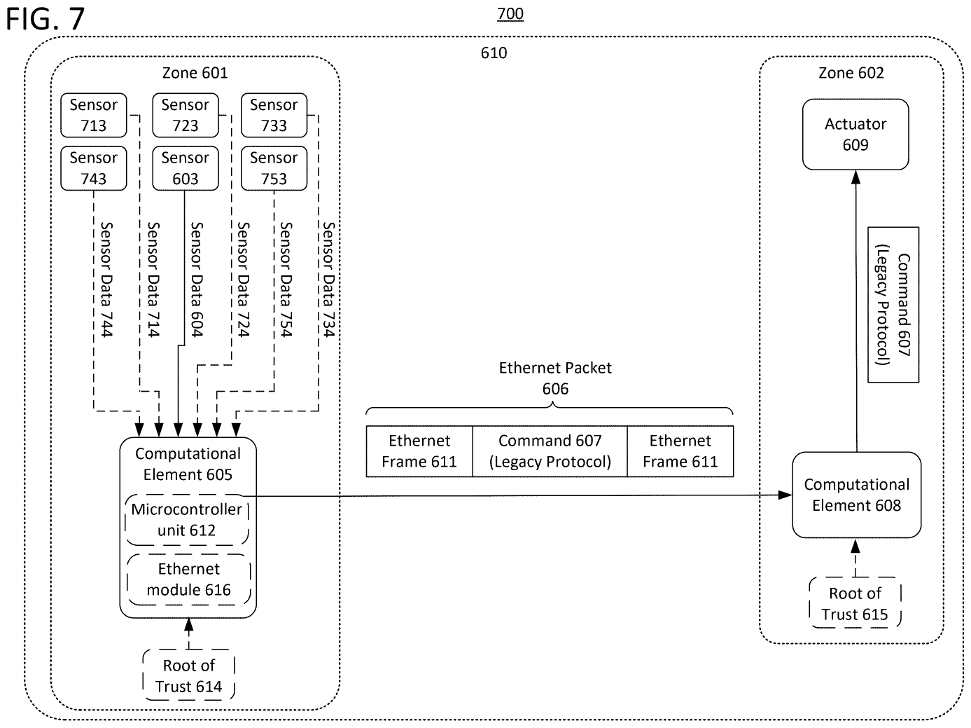

FIG. 7 depicts an example of system 700 packaging a legacy protocol command with Ethernet protocol where the system includes multiple sensors in accordance with specific embodiments of the inventions disclosed herein. System 700 may be an automotive computing architecture and may be similar to system 600, except that additional sensors 713, 723, 743, and 753 are in zone 601. For example, system 700 includes a set of zones (including zone 601 and zone 602), zonal network 610, sensors 603, 713, 723, 743, and 753 in zone 601, actuator 609 in zone 602, computational element 605 in zone 601, and computational element 608 in zone 602. Computational element 605 and computational element 608 may be discrete computational elements and may be endpoint hardware. Although six sensors 603, 713, 723, 733, 743, and 753 are shown, any quantity of sensors is possible in system 700. Additionally, although not shown, specific embodiments may include one or more sensors in zone 602 coupled to computational element 608.

Computational element 605 may be coupled to additional sensors 713, 723, 733, 743, and 753 to receive (e.g., collect) sensor data 714, 724, 734, 744, and 754 respectively. Computational element 605 receive may sensor data 604, 714, 724, 734, 744, and 754 according to a set of legacy protocols. Sensor data 604, 714, 724, 734, 744, and 754 may correspond to the same legacy protocols, different legacy protocols, or a combination thereof. Some sensor data may be absent if the corresponding sensor is off, broken, or has nothing to report. For example, sensor data 604 and sensor data 754 may be LIN, sensor data 724 may be CAN, and sensor 713 may be off such that there is no sensor data 714. Microcontroller unit 612 may include a set of open source software stacks that are compatible with the operating system and the set of legacy protocols.

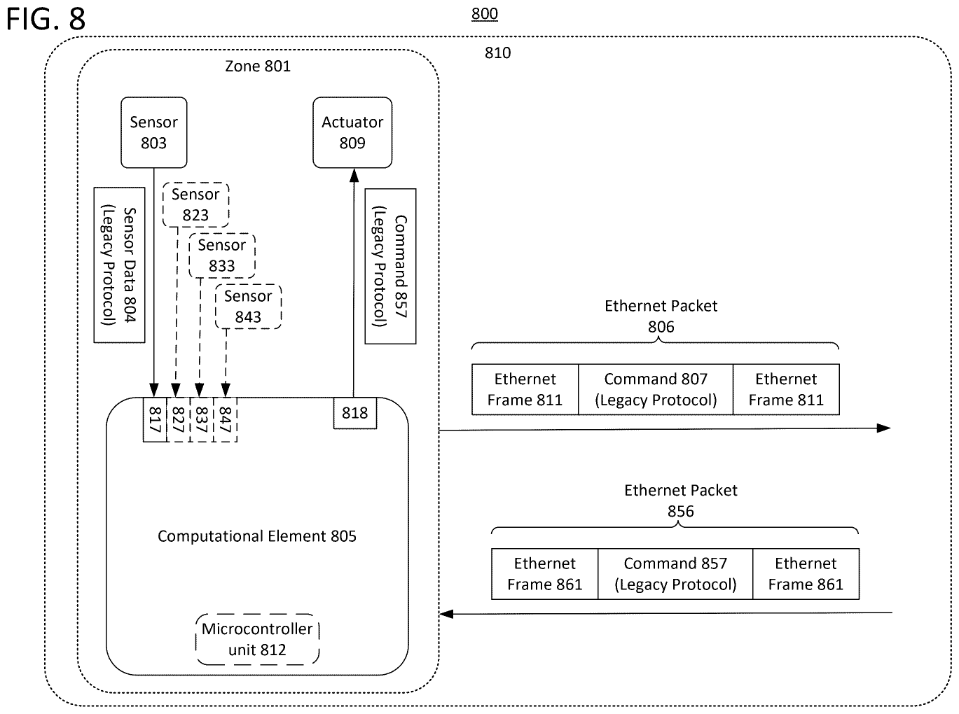

FIG. 8 depicts system 800 with discrete computational element 805 in accordance with specific embodiments of the inventions disclosed herein. System 800 may be part of an automotive computing architecture. Discrete computational element 805 includes sensor coupling 817 and actuator coupling 818. Discrete computational elements 805 may be endpoint hardware and may include or be part of a zone controller. Sensor coupling 817 may enable discrete computational element 805 to receive sensor data according to a legacy protocol from sensor 803 in zone 801. Actuator coupling 818 may enable discrete computational element 805 to send command 807 in the legacy protocol to an actuator in zone 801. Command 807 may be packaged in Ethernet packet 806. Zone 801 may be part of a set of zones of zonal network 810. Sensor coupling 817 and actuator coupling 818 may include wires, contacts, soldering, capacitors, transformers, or any other electric connection and may include conductive coupling, resistive coupling, direct coupling, or inductive coupling.

Aspects of system 800 may be similar to aspects of system 600 or system 700. Discrete computational element 805 may be a packaged computational element. In specific embodiments, discrete computational element 805 may include microcontroller unit 812 with an operating system and an open sources software stack that is compatible with the operating system and the legacy protocol. In specific embodiments, microcontroller unit 812 may be a chiplet.

Discrete computational element 805 may be programmed to collect and process sensor data 804 to produce command 807 based on sensor data 804 and generate Ethernet packet 806 that packages command 807. Command 807 may be in the legacy protocol and Ethernet packet 806 may be for zonal network 810. Command 807 may be packaged in Ethernet packet 806 by incorporating Ethernet frame 811 as part of a message containing command 807.

In specific embodiments, a set of additional sensors couplings 827, 837, and 847 may be configured to be coupled to additional sensors 823, 833, and 843 in zone 801. Although a total of four sensors are shown, system 800 may include any number of sensors and sensor couplings. Discrete computational element 805 may be configured to be coupled to additional sensors 823, 833, and 843 to receive sensor data according to a set of legacy protocols. Microcontroller unit 812 may include a set of open source software stacks that are compatible with the operating system and the set of legacy protocols.

Discrete computational element 805 may be programmed to receive Ethernet packet 856 with command 857 and unpack command 857 into the legacy protocol. For example, discrete computational element 805 may interpret, process, and discard Ethernet frame 861 in Ethernet packet 806 to access command 857. Discrete computational element 805 may provide command 857, as unpacked into the legacy protocol, to actuator 809.

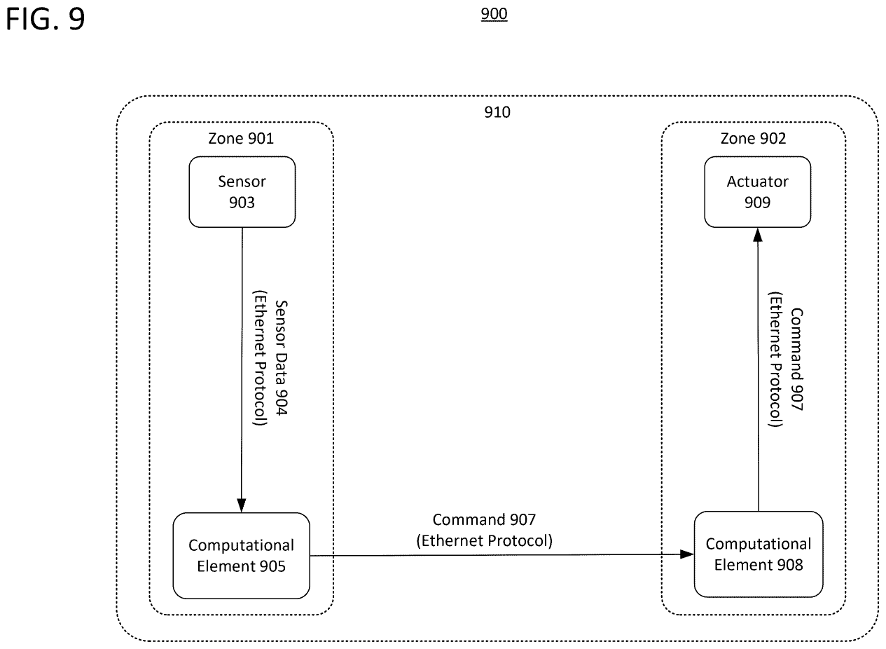

FIG. 9 depicts an example of system 900 using Ethernet protocol for sensor data and commands in accordance with specific embodiments of the inventions disclosed herein. System 900 may be an automotive computing architecture including a set of zones (e.g., zones 901 and 902), zonal network 910, sensor 903 in zone 901, actuator 909 in zone 902, computational element 905 in zone 901, and computational element 908 in zone 902. Computational elements 905 and 908 may be discrete computational elements, may be endpoint hardware, and may include or be part of a zone controller. System 900 may include aspects of system 600, 700, and 800. For example, system 900 may include root of trust modules and one or more microcontroller units even though these aspects are not shown in FIG. 9.

Zonal network 910 may provide communicative coupling between the zones (e.g., zone 901 and zone 902). Sensor 903 may produce sensor data 904 according to an Ethernet protocol. Actuator 909 may understand commands according to the Ethernet protocol. In specific embodiments, a legacy sensor may send its data packets to an “Automotive scale-out chip” where the scale-out chip may contain MCUs that recognize which Legacy protocol the incoming sensor data belongs to (e.g., the MCUs may decode this information from the incoming header packets for the sensor data). Then the automotive scale-out chip may encapsulate the Legacy protocol and send it out via Ethernet (e.g., header and data packets) to recipients. Computational element 905 may be coupled to sensor 903 to receive (e.g., collect) sensor data 904 according to the Ethernet protocol and may be programmed to process sensor data 904 to produce command 907 based on sensor data 904. Command 907 may also be in the Ethernet protocol. Computational element 908 may be coupled to actuator 909. Computational element 908 may be programmed to receive command 907 in the Ethernet protocol and provide command 907 to actuator 909.

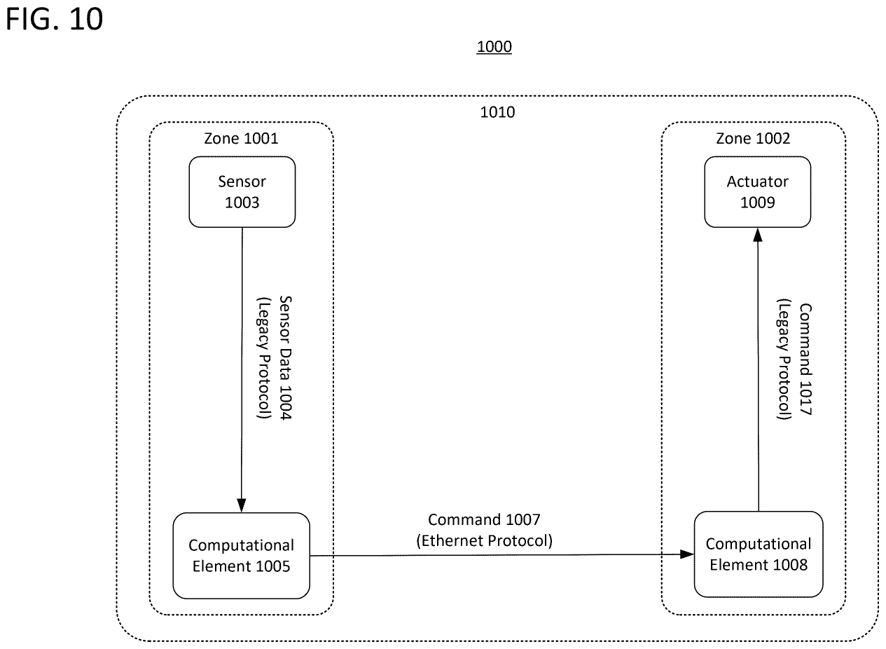

FIG. 10 depicts an example of system 1000 that translates legacy protocols to Ethernet protocol in accordance with specific embodiments of the inventions disclosed herein. For example, system 1000 converts sensor data 1004 in legacy protocol to command 1007 in Ethernet protocol, transmits command 1007 over zonal network 1010, and converts command 1007 in Ethernet protocol to command 1017 in a legacy protocol. System 1000 may be an automotive computing architecture including a set of zones (e.g., zones 1001 and 1002), zonal network 1010, sensor 1003 in zone 1001, actuator 1009 in zone 1002, computational element 1005 in zone 1001, and computational element 1008 in zone 1002. Computational elements 1005 and 1008 may be discrete computational elements, may be endpoint hardware, and may include or be part of a zone controller. System 1000 may include aspects of system 600, 700, 800, and 900. For example, system 1000 may include root of trust modules and one or more microcontroller units even though these aspects are not shown in FIG. 10. Although one sensor 1003 and one actuator 1009 are shown, there may be any number of sensors and actuators in system 1000.

Zonal network 1010 may provide communicative coupling between the zones (e.g., zone 1001 and zone 1002). Sensor 1003 may produce sensor data 1004 according to a legacy protocol (e.g., CAN, LIN). Computational element 1005 may be coupled to sensor 1003 to receive or collect sensor data 1004 according to the legacy protocol and may be programmed to process sensor data 1004 to produce command 1007 based on sensor data 1004. Command 1007 may be in the Ethernet protocol. Computational element 1008 may be coupled to actuator 1009. Computational element 1008 may be programmed to receive command 1007 in the Ethernet protocol, convert command 1007 in Ethernet protocol to command 1017 in a legacy protocol (e.g., CAN, LIN), and provide command 1017 to actuator 1009. Actuator 1009 may understand commands according to the same legacy protocol that sensor 1003 uses or may understand a different protocol. In other words, the legacy protocol of sensor data 1004 may be the same or different than the legacy protocol of command 1017.

Discrete computational elements 1005 and 1008 can assist in the scale out of an automotive computational architecture. Discrete computational element 1005 can process sensor data 1004 for zone 1001 in zonal network 1010 (e.g., an automotive zonal network). Discrete computational element 1005 can communicate with a set of one or more sensors 1003 using various legacy protocols and convert all communication to Ethernet. Discrete computational element 1005 can then communicate with discrete computational element 1008 or higher-level controllers using Ethernet. Discrete computational element 1008 can receive command 1007 for the actuator 1009 using Ethernet and then translate command 1007 into the command 1017 where command 1017 uses the legacy protocol that actuator 1009 uses. Discrete computational element 1008 can send command 1017 downstream to actuator 1009 using various legacy protocols understood by actuator 1009.

In specific embodiments, the discrete computational element 1005 can assist in scaling out automotive computing architectures with sensor 1003 (a legacy sensor) and actuator 1009 (a legacy actuator) by processing the sensor data 1004 and generating command 1017 for actuator 1009 locally, translating command 1017 (legacy protocol) into command 1007 (Ethernet protocol), and sending the command 1007 to zone 1002 (or other zones) where command 1007 can be translated back into command 1017 in the legacy protocol of actuator 1009. This approach leads to beneficial results in that it reduces congestion on zonal network 1010 of system 1000 (e.g., the automotive computing architecture) by processing sensor data (e.g., sensor data 1004) locally within zones (e.g., zone 1001) and only transmitting summaries of that data or command generated in response to the data through zonal network 1010.

In specific embodiments, messages may not need to be translated at both computational element 1005 and computational element 1008 if the sensor or the actuator operates using Ethernet. For example, if a sensor operates using Ethernet but an actuator does not, then computational element 1005 may produce a command in Ethernet protocol from sensor data (in Ethernet protocol) and send the command to computational element 1008, without translating the command. Computational element 908 may translate the command to the legacy protocol understood by the actuator and send the command in the legacy protocol to the actuator. As another example, if an actuator operates using Ethernet but a sensor does not, then computational element 1005 may produce a command in legacy protocol from sensor data (in a legacy protocol) and translate the command to Ethernet protocol. Alternatively, computational element 1005 may receive sensor data in a legacy protocol from the sensor, translate the sensor data to Ethernet protocol, then produce a command in Ethernet protocol from the translated (Ethernet protocol) sensor data. Computational element 1005 may send the command, via Ethernet protocol, to computational element 1008. Computational element 1008 may then relay, without translating, the Ethernet protocol command to the actuator that may operate using Ethernet protocol.

In specific embodiments, discrete computational elements 1005 and 1008 can include operating systems for running software stacks and can be loaded with open-source software stacks to process the sensor data (e.g., sensor data 1004) from various legacy protocols, to translate the sensor data (e.g., sensor data 1004) from various legacy protocols into Ethernet, or to translate commands (e.g., command 1007) received via Ethernet packets into commands (e.g., command 1017) for various legacy protocols. In specific embodiments, computational element 1005 may create encapsulated packets for the Legacy protocol to be transferred via Ethernet. Computational element 1008 may unpack the Ethernet packets, may recognize in the Ethernet header packet which Legacy protocol is encapsulated, and may decode the data payload with its Legacy header and data packet to be sent as legacy command 1017 to actuator 1009. In specific embodiments, the software stacks used to translate commands received via Ethernet packets can be modified by the manufacturer of the computational elements to operate with a proprietary protocol in which the commands are issued as set by the developer of the automotive computing architecture.

In specific embodiments, sensor data 1004 may be an X byte or an analog legacy signal. Computational element 1005 may translate the X byte or the analog legacy signal into a new format that may contain all the associated data, where the new format may fit in a single Ethernet packet. Scale out chips may understand Ethernet protocol. The Ethernet protocol format of the X byte or the analog legacy signal (e.g., command 1007) may be sent through zonal network 1010 and received at a scale out chip. The scale out chip may translate the Ethernet format of the X byte or the analog legacy signal back into the legacy protocol (e.g., command 1017) and sent to actuator 1009. Translating legacy protocol commands in Ethernet protocol allows the efficiency and reliability of Ethernet protocol through the zonal network while. This may improve efficiency and reduce latency for communicating commands and other messages.

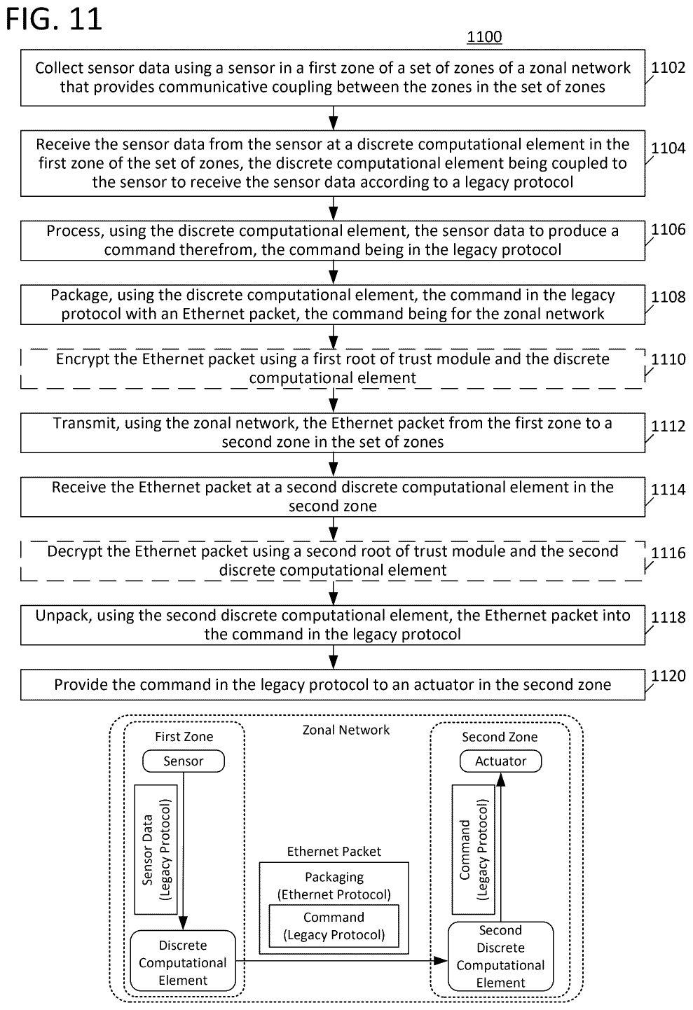

FIG. 11 depicts an example of method 1100 of operating an automotive computing architecture in accordance with specific embodiments of the inventions disclosed herein. Method 1100 may be implemented by a system including a set of zones, a zonal network, a sensor, an actuator, a discrete computational element, and a second discrete computational element. In specific embodiments, the system may include a microcontroller, a set of additional sensors, a first root of trust, a second root of trust, and an Ethernet module. In specific embodiments, method 1100 may be implemented by a system including means for performing the steps of method 1100. Steps, or portions of steps, of method 1100 may be omitted, duplicated, rearranged, or otherwise deviate from the example shown.

At step 1102, sensor data may be collected using a sensor in a first zone of a set of zones of a zonal network. The zonal network may provide communicative coupling between zones in the set of zones.

At step 1104, the sensor data may be received at a discrete computational element. The discrete computational element may be coupled to the sensor to receive the sensor data according to a legacy protocol. The legacy protocol may be CAN, LIN, etc. In specific embodiments, the discrete computational element is a packaged computational element. In specific embodiments, the discrete computational element is coupled to a set of additional sensors to receive sensor data according to a set of legacy protocols.

At step 1106, the sensor data may be processed using the discrete computational element to produce a command therefrom (e.g., based on the sensor data). The command may be in the legacy protocol. In specific embodiments, the discrete computational element includes a microcontroller unit for processing the sensor data to produce a command therefrom. In specific embodiments, the microcontroller unit is a chiplet. In specific embodiments, the microcontroller unit may have an operating system and an open source software stack that is compatible with the operating system and the legacy protocol. In specific embodiments where the discrete computational element is coupled to a set of additional sensors to receive sensor data according to a set of legacy protocols, the microcontroller unit may include a set of open source software stacks that are compatible with the operating system and the set of legacy protocols,

At step 1108, the command (that is in the legacy protocol) may be packaged with an Ethernet packet. The command may be packaged using the discrete computational element. The command may be intended for (e.g., sent through) the zonal network. In specific embodiments, the discrete computational element may include an Ethernet module for packaging the command in the legacy protocol into the Ethernet packet.

In specific embodiments, at step 1110, the Ethernet packet may be encrypted using a first root of trust module and the discrete computational element. In specific embodiments, the discrete computational element may include a first root of trust module used by the discrete computational element to encrypt the Ethernet packet.

At step 1112, the Ethernet packet may be transmitted from the first zone to a second zone in the set of zones. The Ethernet packet may be transmitted using the zonal network.

At step 1114, the Ethernet packet may be received at a second discrete computational element in the second zone. In specific embodiments, the command may go from the first zone to the second zone without additional computational processing such as by an engine control unit.

In specific embodiments, at step 1116, the Ethernet packet may be decrypted. The Ethernet packet may be decrypted using a second root of trust module and the second discrete computational element.

At step 1118, the Ethernet packet may be unpacked into the command in the legacy protocol. The Ethernet packet may be unpacked using the second discrete computational element.

At step 1120, the command in the legacy protocol may be provided to an actuator in the second zone. Packaging legacy protocol commands in Ethernet protocol allows the efficiency and reliability of Ethernet protocol through the zonal network while avoiding translating commands or other messages. This may improve efficiency and reduce latency for communicating commands and other messages.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. Although examples in the disclosure were generally directed to chiplets, the same approaches could be utilized to traditionally packaged integrated circuits which are incorporated into an automotive computing architecture via a printed circuit board or interposer. Although examples in the disclosure were generally directed to automotive computing architectures using Ethernet, the same approaches can be applied to automotive computing architectures using other packetized networking protocols or networking protocols generally. These and other modifications and variations to the present invention may be practiced by those skilled in the art, without departing from the scope of the present invention, which is more particularly set forth in the appended claims.

What is claimed is:

1. An automotive computing architecture comprising:
a set of zones;
a zonal network providing communicative coupling between the zones in the set of zones;
a sensor in a first zone of the set of zones;
an actuator in a second zone of the set of zones;
a discrete computational element, in the first zone of the set of zones, that is coupled to the sensor to receive sensor data according to a legacy protocol, and that is programmed to: (i) process the sensor data to produce a command therefrom, the command being in the legacy protocol; and (ii) package the command for the zonal network, the command being packaged as an Ethernet packet; and
a second discrete computational element, in the second zone of the set of zones, that is coupled to the actuator, and that is programmed to: (i) receive the Ethernet packet with the command; (ii) unpack the command into the legacy protocol, and (iii) provide the command, unpacked into the legacy protocol, to the actuator.

2. The automotive computing architecture of claim 1, wherein:
the discrete computational element is a packaged computational element; and
the discrete computational element includes a microcontroller unit for processing the sensor data to produce a command therefrom.

3. The automotive computing architecture of claim 2, wherein:
the microcontroller unit is a chiplet.

4. The automotive computing architecture of claim 1, wherein:
the discrete computational element is a packaged computational element; and
the discrete computational element includes a microcontroller unit with an operating system and an open source software stack that is compatible with the operating system and the legacy protocol.

5. The automotive computing architecture of claim 4, further comprising:
a set of additional sensors in the first zone of the set of zones;
wherein: (i) the discrete computational element is coupled to the set of additional sensors to receive sensor data according to a set of legacy protocols; and (ii) the microcontroller unit includes a set of open source software stacks that are compatible with the operating system and the set of legacy protocols.

6. The automotive computing architecture of claim 1, further comprising:
a first root of trust module used by the discrete computational element to encrypt packets sent on the zonal network, wherein the packets sent on the zonal network include the Ethernet packet; and
a second root of trust module used by the second discrete computational element to decrypt the packets sent on the zonal network.

7. The automotive computing architecture of claim 1, further comprising:
a microcontroller unit for processing the sensor data to produce a command therefrom;
an Ethernet module for packaging the command as the Ethernet packet; and
a first root of trust module used by the discrete computational element to encrypt packets sent on the zonal network, wherein the packets sent on the zonal network include the Ethernet packet;
wherein the discrete computational element is a packaged computational element.

8. The automotive computing architecture of claim 1, wherein:
the command goes from the first zone to the second zone without additional computational processing such as by an engine control unit.

9. A method of operating an automotive computing architecture comprising:
collecting sensor data using a sensor in a first zone of a set of zones of a zonal network, the zonal network providing communicative coupling between the zones in the set of zones;
receiving the sensor data from the sensor at a discrete computational element in the first zone of the set of zones, the discrete computational element being coupled to the sensor to receive the sensor data according to a legacy protocol;
processing, using the discrete computational element, the sensor data to produce a command therefrom, the command being in the legacy protocol;
packaging, using the discrete computational element, the command in the legacy protocol with an Ethernet packet, the command being for the zonal network;
transmitting, using the zonal network, the Ethernet packet from the first zone to a second zone in the set of zones;
receiving the Ethernet packet at a second discrete computational element in the second zone;
unpacking, using the second discrete computational element, the Ethernet packet into the command in the legacy protocol; and
providing the command in the legacy protocol to an actuator in the second zone.

10. The method of claim 9, wherein:
the discrete computational element is a packaged computational element; and
the discrete computational element includes a microcontroller unit for processing the sensor data to produce a command therefrom.

11. The method of claim 10, wherein:
the microcontroller unit is a chiplet.

12. The method of claim 9, wherein:
the discrete computational element is a packaged computational element; and
the discrete computational element includes a microcontroller unit with an operating system and an open source software stack that is compatible with the operating system and the legacy protocol.

13. The method of claim 12, wherein:
the discrete computational element is coupled to a set of additional sensors to receive sensor data according to a set of legacy protocols; and
the microcontroller unit includes a set of open source software stacks that are compatible with the operating system and the set of legacy protocols.

14. The method of claim 9, further comprising:
encrypting the Ethernet packet using a first root of trust module and the discrete computational element; and
decrypting the Ethernet packet using a second root of trust module and the second discrete computational element.

15. The method of claim 9, wherein:
the discrete computational element includes a microcontroller unit for processing the sensor data to produce a command therefrom;
the discrete computational element includes an Ethernet module for packaging the command in the legacy protocol into the Ethernet packet; and
the discrete computational element includes a first root of trust module used by the discrete computational element to encrypt the Ethernet packet.

16. The method of claim 9, wherein:
the command goes from the first zone to the second zone without additional computational processing such as by an engine control unit.

17. A discrete computational element, for an automotive computing architecture, comprising:
a sensor coupling to receive sensor data according to a legacy protocol from a sensor in a first zone of a set of zones in a zonal network; and
an actuator coupling to send a command in the legacy protocol to an actuator in the first zone;
wherein the discrete computational element is programmed to: (i) process the sensor data to produce a command therefrom; (ii) generate an Ethernet packet that packages the command, where the command is in the legacy protocol and the Ethernet packet is for the zonal network; (iii) receive a second Ethernet packet with a second command; (iv) unpack the command into the legacy protocol; and (iv) provide the second command, as unpacked into the legacy protocol, to the actuator.

18. The discrete computational element of claim 17, wherein:
the discrete computational element is a packaged computational element; and
the discrete computational element includes a microcontroller unit with an operating system and an open source software stack that is compatible with the operating system and the legacy protocol.

19. The discrete computational element of claim 18, further comprising:
a set of additional sensor couplings configured to be coupled to additional sensors in the first zone of the set of zones;
wherein: (i) the discrete computational element is configured to be coupled to the additional sensors to receive sensor data according to a set of legacy protocols; and (ii) the microcontroller unit includes a set of open source software stacks that are compatible with the operating system and the set of legacy protocols.

20. The discrete computational element of claim 19, wherein:
the microcontroller unit is a chiplet.

21. An automotive computing architecture comprising:
a set of zones;
a zonal network providing communicative coupling between the zones in the set of zones;
a sensor, in a first zone of the set of zones, that produces sensor data according to an Ethernet protocol;
an actuator, in a second zone of the set of zones, that understands commands according to the Ethernet protocol;
a discrete computational element, in the first zone of the set of zones, that is coupled to the sensor to receive sensor data according to the Ethernet protocol, and that is programmed to process the sensor data to produce a command therefrom, the command being in the Ethernet protocol; and
a second discrete computational element, in the second zone of the set of zones, that is coupled to the actuator, and that is programmed to: (i) receive the command in the Ethernet protocol; and (ii) provide the command to the actuator.
